(19) United States
(12) Patent Application Publication
(10) Pub. No.: US 2013/0289346 A1
(43) Pub. Date: Oct. 31, 2013

(54) Sexual Stimulation Aid and Article of Jewelry

(71) Applicant: Christine Florence Standfest, Mancelona, MI (US)

(72) Inventor: Christine Florence Standfest, Mancelona, MI (US)

(21) Appl. No.: 13/988,408

(22) PCT Filed: Nov. 21, 2011
(86) PCT No.: PCT/US11/61612

§ 371 Date: May 20, 2013

Related U.S. Application Data
(60) Provisional application No. 61/458,318, filed on Nov. 22, 2010.

(51) Int. Cl. A61H 19/00

(52) U.S. Cl. CPC A61H 19/00
USPC 600/38

(57) ABSTRACT

A combination sexual aid and jewelry device comprising a housing for holding a power source connected to a first and a second flexible arm, where each of the first and second flexible arms has a distal end where at least one of the distal ends is equipped with an electro/mechanical vibrator for causing a vibrating motion; and wherein the power source provides electrical power to the electro/mechanical vibrator.

This application claims priority of United States Provisional Patent Application of Christine Florence Standfest et al., Ser. No. 61/458,318 for QUICKI JEWELRY/SEXUAL TOY, filed on 22 Nov., 2010.

### BACKGROUND OF THE INVENTION

1. Field of the Invention

This patent application pertains to a sexual stimulation device, and more specifically, pertains to a sexual stimulation device which can also be worn as jewelry such as a bracelet or necklace. Even more specifically, this patent application relates to sexual stimulation device suitable for use on both men and women.

2. Background

There are numerous devices commercially available that provide sexual stimulation. These devices are generally either non-vibratory or provide a means for creating a vibration. Further, these devices are generally suited for either a man or a woman, but not for use by either sex. Devices for use by a woman are generally phallus shaped and are manipulated in and around the genital region of the woman. Further devices provide for additional stimulation of a woman's clitoris and/or anus. Devices for use by a man are generally designed to fit over the penis similar to a condom so that these devices can then stimulate the penis.

Sexual aid devices are generally small and compact in shape for a variety of reasons. First, the anatomical considerations place a limit on the overall girth and length of the device. Second, these devices need to be small in size to provide ease of portability and user operation. Lastly, privacy considerations necessitate that these devices be compact and easily stored in a bag or drawer when not in use. However, the small size of the devices adversely affects the ability to manipulate the device during use. Thus, it is desirable to have a longer, more easily manipulated sexual aid device.

U.S. Pat. No. 7,081,087 to Jannuzzi provides a vibrating sexual aid device having a generally J-shaped design. The shorter arm or the J-shape is inserted into the vagina. The curve of the J-shape allows the longer arm of the J-shape to be direct upwards towards the torso of the user. The longer arm is used to manipulate the device and to control the vibration function acting on the shorter arm. An additional vibratory region is included to provide clitoral stimulation. While the '087 provides for greater manipulation of the device, it suffers from a number of drawbacks. First, this device is designed to be used only to stimulate a woman's genital area. Second, this device is directed to masturbatory use by a woman and excludes interactions with her partner. Lastly, this device would be clearly identified in public as a sexual aid device thereby possibly causing embarrassment to the owner if it should be seen by a member of the general public.

U.S. Pat. No. 7,931,605 and United States patent application publication 2011/0124959, both to Murison, describe a generally U-shaped device for providing sexual stimulation to a woman. One arm of the device is to be inserted into the vagina while the U-shaped turn directs the second arm which possesses the power/vibration controls upwards towards the woman's torso. Vibrators are position within the device to simultaneously provide vibratory stimulation of the vaginal wall, the G-spot, and the clitoris. Again, the '605 patent and '959 application suffer a number of drawbacks. First, this device is designed to be used only to stimulate a woman's genital area. Second, this device is directed to masturbatory use by a woman and excludes interactions with her partner. Lastly, this device would be clearly identified in public as a sexual aid device thereby possibly causing embarrassment to the owner if it should be seen by a member of the general public.

Thus, it is readily apparent that there is a long-felt need for a sexual aid device that can be used to stimulate either or both a man and a woman which can also be worn in public without causing embarrassment or public stigmatization.

### SUMMARY OF THE INVENTION

It is the object of the disclosure to provide a pliable sexual stimulation device which can further be worn as an article of jewelry such as a bracelet, anklet, necklace, or a watch.

It is another object of the disclosure to provide a pliable sexual stimulation device which can further be worn as an article of jewelry where each end of the device encapsulates a vibrator.

Yet another object of the invention is to provide a pliable sexual stimulation device which can be used to stimulate the erogenous zones of a woman or a man.

The objects of the invention are achieved by provision of a sexual aid device having a first end and a second end each equipped with electro/mechanical means for causing a vibration motion and a connecting portion connecting the first and second ends where the connecting portion is equipped with a means for providing and controlling electrical power to the electro/mechanical means. The sexual aid device is constructed of a flexible wire encased in a pliable elastomeric material. The flexibility of the device permits the device to be worn around the neck or wrist when worn as an article of jewelry and elongated or otherwise manipulated when used as a sexual aid device.

### DESCRIPTION OF THE DRAWINGS

The present disclosure and the manner in which it may be practiced is further illustrated with reference to the accompanying drawings wherein:

FIG. 1 is a side perspective view of a sexual aid device of one embodiment of the present disclosure.

FIG. 2 is an exploded view of a sexual aid device of one embodiment of the present disclosure.

FIG. 3 is a side perspective view of a sexual aid device of a second embodiment of the present disclosure.

FIG. 4 is a top view of a sexual aid device of a third embodiment of the present disclosure.

FIG. 5 is a cross sectional view of a sexual aid device of a third embodiment of the present disclosure taken generally across arrows 5-5 of FIG. 4.

FIG. 6 is a side perspective view of a sexual aid device of a fourth embodiment of the present disclosure.

FIG. 7 is a side perspective view of an internal frame for use in an embodiment of a sexual aid device of the present disclosure.

FIG. 8 is a side perspective view of a second internal frame for use in an embodiment of a sexual aid device of the present disclosure.

FIG. 9 is a top view of a fifth embodiment of a sexual aid device of the present disclosure.

FIG. 10 is a cross sectional view of a fifth embodiment of a sexual aid device of the present disclosure taken generally across arrows 10-10 of FIG. 9.

### DETAILED DESCRIPTION OF THE INVENTION

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. §112.

The present disclosure overcomes the above mentioned drawbacks by provision of a pliable sexual aid device having a first end and a second end each possessing a vibrator. A malleable connecting portion joins the first and second ends and is equipped with an on/off switch for one or both vibrators and an adjustable speed controller to regulate the speed and/or intensity of vibration. The pliable sexual aid device is constructed of a flexible wire encased in a waterproof malleable elastomeric material. The flexibility of the device permits the device to be worn around the neck or wrist when worn as an article of jewelry and elongated or otherwise manipulated when used as a sexual aid device. The device can be manipulated to simultaneously stimulate various erogenous zones of a man and/or a woman. The sexual aid device can be coiled such that it wraps around the penis. The vibrators can be position to stimulate the head and/or base of the penis, as well as the testicles. Alternatively, the device can be adjusted such that one vibrator stimulates a portion of the penis while the second stimulates the anus. Similarly, when used with a woman, the vibrators can be position such that one or both vibrators stimulate the clitoris, vagina, and/ or anus. Additionally, the malleability of the device permits one partner to manipulate the position and vibration of the device when being used on the second partner.

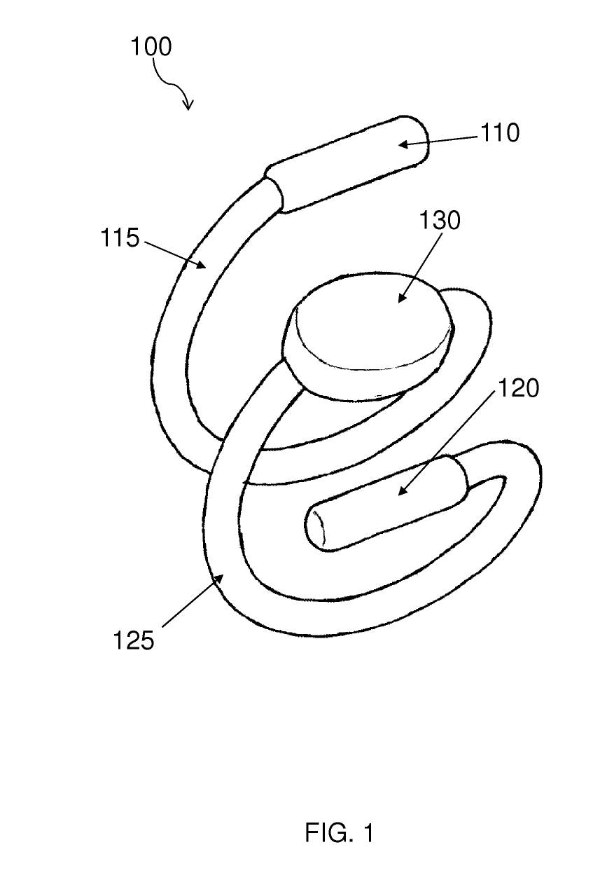

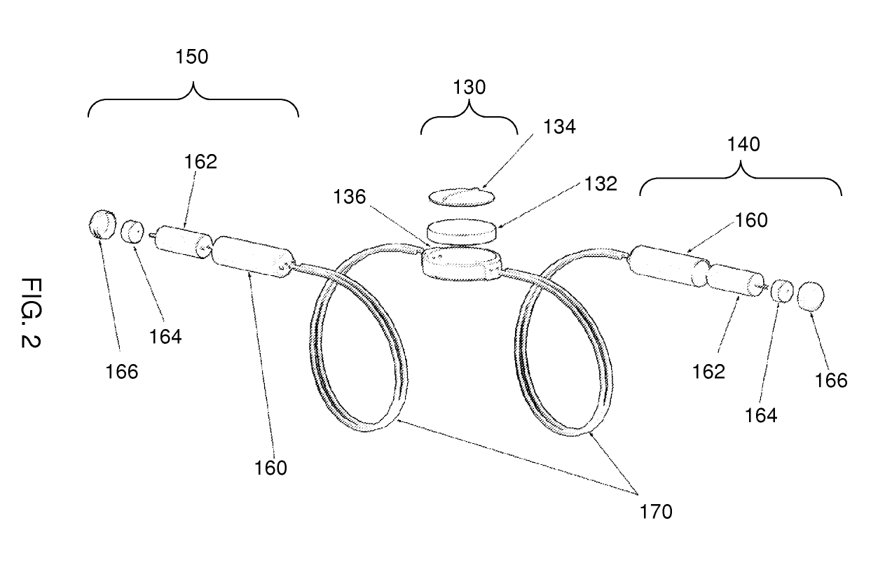

Adverting now to the drawings, with reference to FIG. 1, a first embodiment of the present disclosure is indicated generally by numeral 100. Sexual aid device 100 is generally comprised of a pliable rod-like unit having a first end 110 and a second end 120. The unit is constructed of silicone, rubber, vinyl, thermoplastic elastomer or any other suitable material. The unit is waterproof to prevent water or body fluids from contacting the internal portions of the device (as shown in FIG. 2). The unit is also durable so that it can withstand fairly vigorous use and subsequent cleanings. The unit is further equipped with a housing 130 containing a power supply and control means. Interposed between end 110 and housing 130 is flexible arm 115, while flexible arm 125 is interposed between end 120 and housing 130.

Ends 110 and 120 are rounded so as to be comfortably inserted in a user's vagina or anus. In preferred embodiments, ends 110 and 120 are rounded-over cylinders so as to minimize public discernment as a sexual aid device. However, alternative shapes can be used such as knobbed or ribbed elements or shapes that resemble the head of a penis. While any girth and length of ends 110 and 120 are envisioned, in preferred embodiments, the girth and length of ends 110 and 120 are selected so as to comfortably fit within a vagina and/or anus to provide a user with sexual satisfaction and enjoyment. At least one end is further sized to fit snuggly within the lips of the vulva to provide direct clitoral stimulation. In preferred embodiments, ends 110 and 120 each hold a vibrator. Flexible arms 115 and 125 are pliable enough so that each arm bends into any desired position yet remains resilient enough to retain that desired position.

FIG. 2 provides an exploded view of a sexual aid device of one embodiment of the present disclosure. The external shell has been removed for increased clarity. Vibrator 140, located proximate end 110 (see FIG. 1) and vibrator 150, located proximate end 120 (see FIG. 1) are each constructed of vibrator motor housing 160 into which is inserted motor 162 having a distal end and a proximal end. Weight 164 is mounted onto a shaft at the distal end of motor 162. Preferably, weight 164 is an eccentric weight supported in a cantilever-fashion by a motor shaft on vibrating motor 162. Cap 166 is affixed to motor housing 160 such that motor 162 and weight 164 are maintained within the capped motor housing. Motor 162 induces a vibration force on weight 164 when a DC current is applied to motor 162. Although described as a weighted motor, vibration may be imparted using any suitable known means.

Housing 130 contains a power supply and control means which has a power source such as a battery 132. Battery 132 is a disposable NiCd battery or, more preferably, a rechargeable battery such as a lithium ion battery and the like. Power and/or intensity of vibration is controlled by switch 134. Battery 132 is placed within battery housing 136 and secured with switch 134. As shown in FIG. 2, a non-rechargeable battery is used and switch 134 further functions as a re-sealable access means. A discharged battery can be replaced and the housing resealed to prevent moisture from corroding the electrical components. Switch 134 can be any suitable switching mechanism such as a sliding switch or a push-button on/off toggle switch. Preferably, switch 134 is provided with any number of “on” settings which control whether one or both vibrators are activated, and which control the speed and/or intensity of the resultant vibration. Wires 170 direct DC current from battery 132 to the proximal end of motors 162.

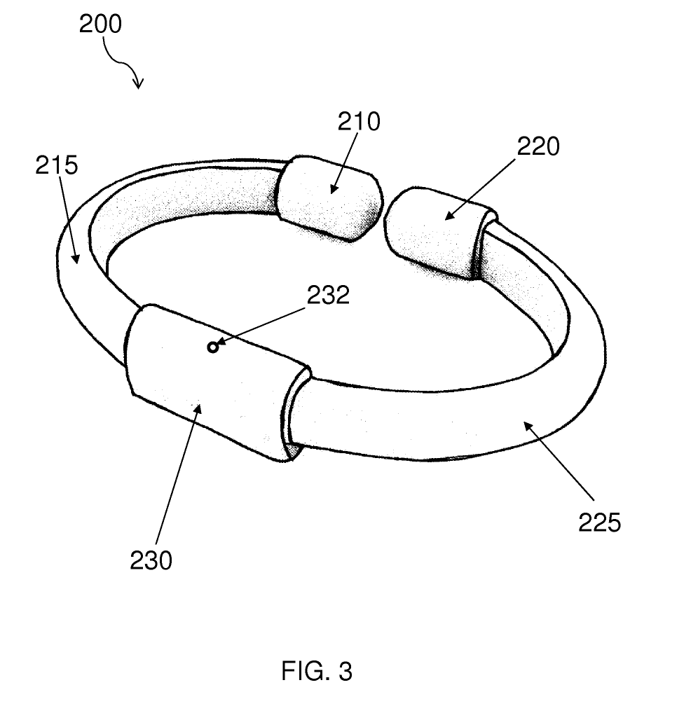

FIG. 3 is a side perspective view of a sexual aid device 200 of a second embodiment of the present disclosure. Sexual aid device 200 is similarly constructed to sexual aid device 100 as discussed above in reference to FIG. 1. Sexual aid device 200 is generally comprised of a pliable rod-like unit having a first end 210 and a second end 220. The unit is further equipped with housing 230 which contains a power supply and control means. Interposed between end 210 and housing 230 is flexible arm 215, while flexible arm 225 is interposed between end 220 and housing 230. Sexual aid device 200 is equipped with a rechargeable battery (not shown) contained within housing 230. Housing 230 is provided with recharging port 232 for coupling an external power cord for use in recharging a battery. The unit is constructed of silicone, rubber, vinyl, thermoplastic elastomer or any other suitable material and is waterproof to prevent water or body fluids from contacting the internal portions of the device.

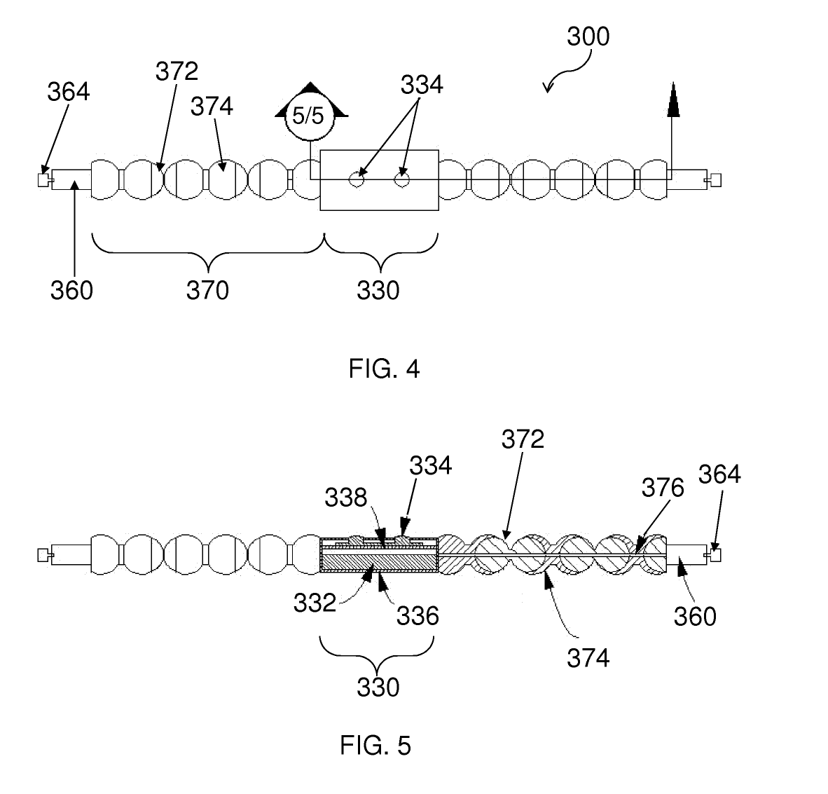

FIG. 4 is a top view of a sexual aid device 300 of a third embodiment of the present disclosure. Sexual aid device 300 is generally comprised of a pair of arms constructed of interlocking ball-and-socket members. Each arm has an end affixed to a housing for power supply and control means while the opposite end is equipped with a vibrating element.

As shown in FIG. 4, arm 370 is composed of alternating interlocking members 372 and 374. Female member 374 is generally hour-glass shaped with the external ends forming a cup-shaped opening. Male member 372 has a corresponding generally hour-glass shape such that its external ends fit snuggly within the cup-shaped opening of female member 374. When engaged with one another, male member 372 and female member 374 form a generally spherical shape with male member 372 able to pivot freely within the cup of female member 374. Thus, arm 370 is able to be conformed into a number of orientations. Friction between members 372 and 374 permits arm 370 to maintain its desired position.

The distal end of arm 370 is equipped with a vibrating element composed of a motor within motor housing 360 and weight 364. Sexual aid device 300 is shown without shaped ends covering motor housing 360 and weight 364. In a preferred embodiment, sexual aid device 300 is constructed with ends similar to end 210 and end 220 as shown in FIG. 3. However, alternative shapes can be used such as knobbed or ribbed elements or shapes that resemble the head of a penis. Power is supplied to the motor within the motor housing by way of a power supply and control means contained within housing 330. Housing 330 has a power source such as a disposable NiCd battery or, more preferably, a rechargeable battery such as a lithium ion battery and the like. Control buttons 334 provide any number of “on” settings which control whether one or both vibrators are activated, as well as controlling the speed and/or intensity of the resultant vibration. Although shown as buttons, the controllers can be any suitable switching mechanism such as a sliding switch or a dial switch.

FIG. 5 is a cross sectional view of a sexual aid device of a third embodiment of the present disclosure taken generally across arrows 5-5 of FIG. 4. FIG. 5 shows in greater detail the orientation and relationship between female member 374 and male member 372 in construction of arm 370. Arm 370 is further equipped with run 376 which is in communication between battery 332 and motor housing 360. Conductive wiring circuits between battery 332 and a motor housed in motor housing 360. When powered by battery 332, the motor causes weight 364 to create a vibratory motion. Battery 332 is housed in casing 336. Control buttons 334 provide any number of “on” settings which control whether one or both vibrators are activated, as well as controlling the speed and/or intensity of the resultant vibration. In a preferred embodiment, power supply and control means is further equipped with circuit board 338 which controls the functioning of control buttons 334 when controlling powering of the device and the speed, strength or rate of vibration.

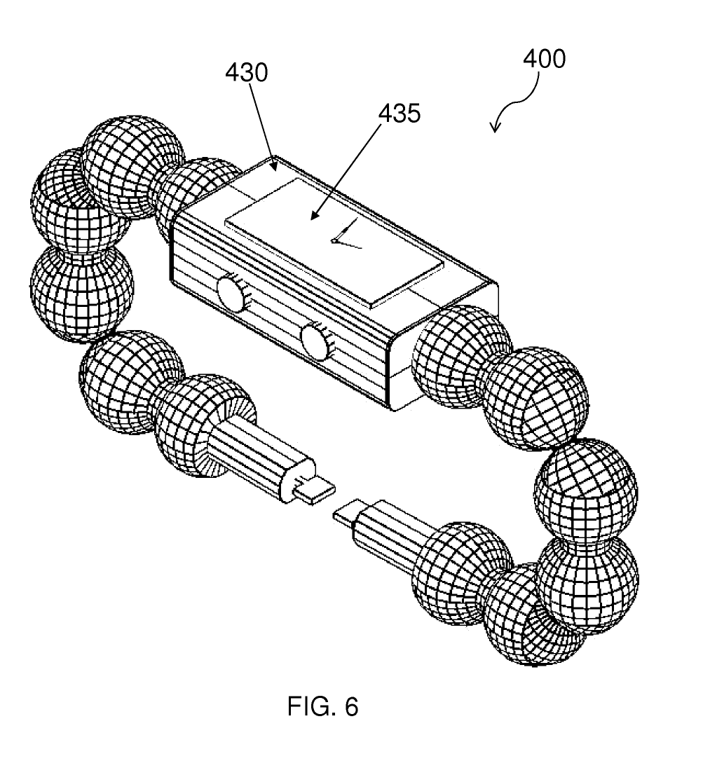

With reference to FIG. 6, a fourth embodiment of a sexual aid device of the present disclosure is indicated generally by numeral 400. Sexual aid device 400 is constructed similarly to sexual aid 300 (as shown in FIGS. 4 and 5) but with the addition of time piece 435 contained within housing 430. Time piece 435 is an analog or digital clock. Sexual aid device 400 thus further functions as a wrist watch when worn around the wrist. Sexual aid device 400 is shown without shaped ends. In a preferred embodiment, sexual aid device 400 is constructed with ends similar to end 210 and end 220 as shown in FIG. 3. However, alternative shapes can be used such as knobbed or ribbed elements or shapes that resemble the head of a penis.

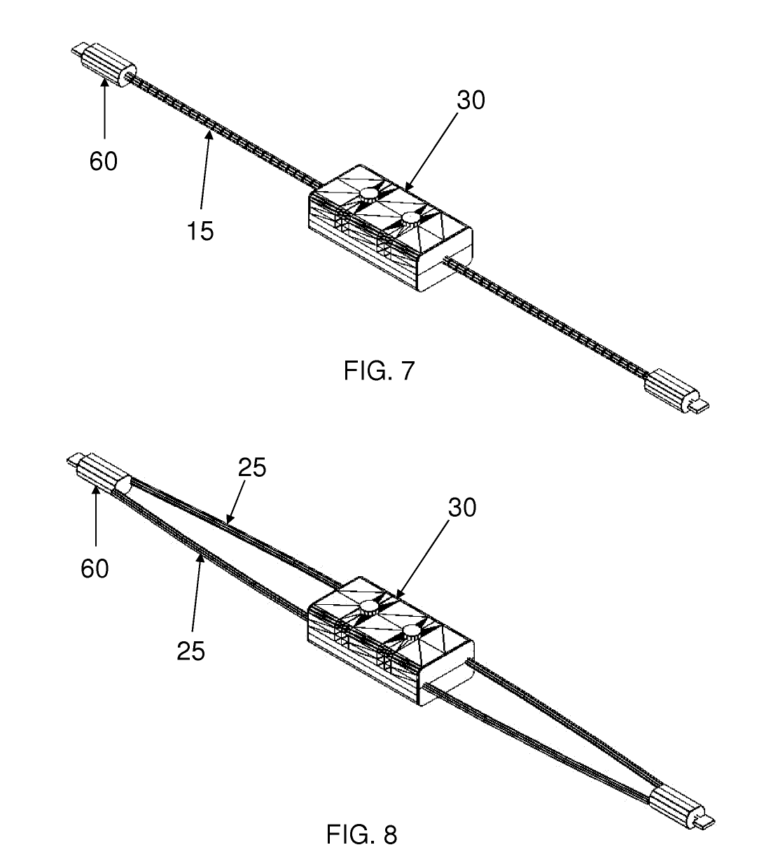

FIG. 7 is a side perspective view of an internal frame for use in an embodiment of a sexual aid device of the present disclosure. A key aspect of the present disclosure is the repeatable bendability of the flexible arms of the device. The repeatable bendability allows the user to straighten or bend the device so as to contact specific erogenous zones during sexual stimulation, while also allowing the user to bend the device sp that it can be worn as a selected article jewelry such as a bracelet, anklet or necklace. As shown in FIG. 7, flexible arm 15 is interposed between and connects housing 30 containing a power supply and control means to a motor in motor housing 60. Electrical wiring is runs the length of flexible arm and is protected by the flexible arm such that the wiring cannot kink or be bent at a sharp angle. The flexible are prevents breakage of the wire and loss of electrical connection. Flexible arm 15 is an aluminum coil capable of being bent into numerous positions yet is rigid enough to maintain fixed within the desired position. Flexible arm 15 is suitable for use in any of the above described embodiments of a sexual aid device, i.e. those devices shown and described in FIGS. 1, 3, 4 and 6.

FIG. 8 is a side perspective view of a second internal frame for use in an embodiment of a sexual aid device of the present disclosure. As shown in FIG. 8, the skeleton of the internal frame consists of two flexible arms 25 interposed between housing 30 and motor housing 60. Flexible arms 25 are aluminum coils capable of being bent into numerous positions yet are rigid enough to maintain the desired position. Electrical wiring runs within the flexible arm creating a completed circuit between the battery in housing 30 and the motor housed in motor housing 60. In one embodiment, both feed and return wires are located within the same flexible coil, while in a second embodiment the feed wire is in one coil while the return wire is in the opposite coil. In either case, a completed circuit is created for powering the vibrational movement at the distal ends of the sexual aid device. Flexible arms 25 are suitable for use in the above described embodiments of a sexual aid device shown and described in FIGS. 1 and 3.

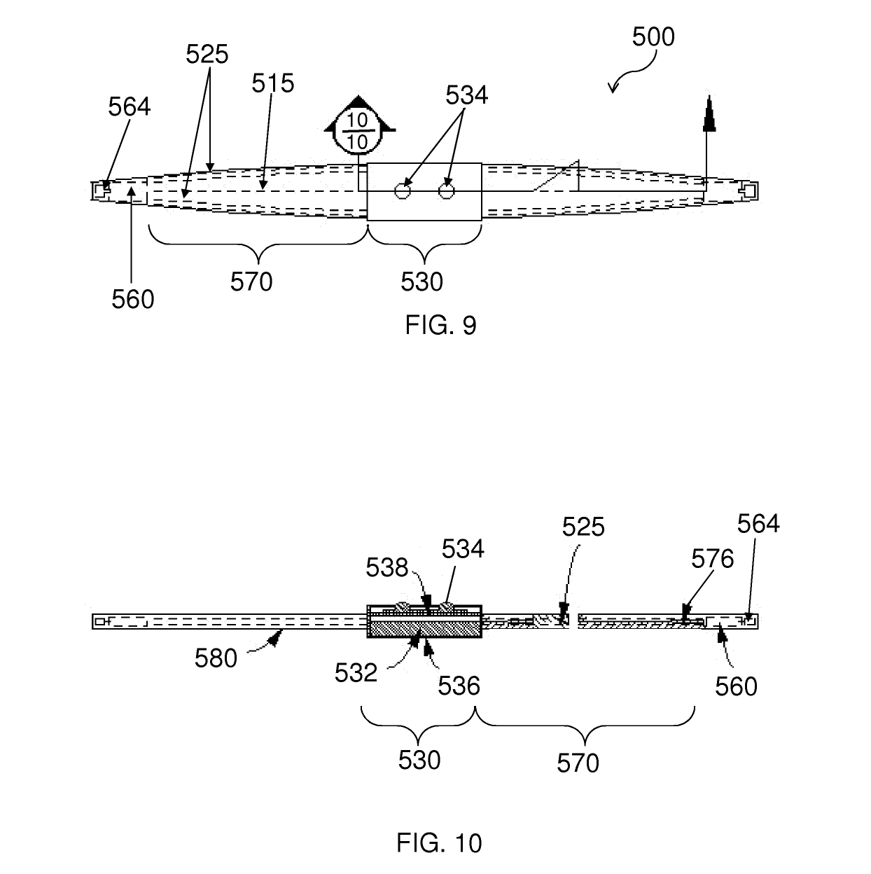

With reference to FIG. 9, a top view of a fifth embodiment of a sexual aid device of the present disclosure is indicated generally by numeral 500. Sexual aid device 500 is generally comprised of a pair of arms 570 having a proximal end affixed to housing 530 while the opposite, distal end is connected to motor housing 560. Power is supplied to the motor housing by way of a power supply and control means within housing 530. Housing 530 has a power source such as a disposable NiCd battery or, more preferably, a rechargeable battery such as a lithium ion battery and the like. Control buttons 534 provide any number of “on” settings which control whether one or both vibrators 564 are activated, as well as controlling the speed and/or intensity of the resultant vibration. Although shown as buttons, the controllers can be any suitable switching mechanism such as a sliding switch or a dial switch. The skeletal frame of arm 570 combines the single, central arm shown in FIG. 7 with the pair of lateral arms shown in FIG. 8. Each arm of the sexual aid device has an internal frame consisting of central flexible arm 515 and a pair of lateral flexible arms 525 situated within a single plane. The three arms restrict lateral movement (side-to-side) within the plane but allow movement perpendicular to the plane. The perpendicular movement allows the user to wrap the device around a wrist when worn as an article of jewelry or as a wrist watch.

FIG. 10 is a cross sectional view of fifth embodiment of a sexual aid device of the present disclosure taken generally across arrows 10-10 of FIG. 9. Arm 570 is further equipped with run 576 which is in communication between housing 530 and motor housing 560. Conductive wiring completes a circuit between battery 532 and a motor housed in motor housing 560. When powered by battery 532, the motor causes weight 564 to create a vibratory motion. Battery 532 is housed in casing 536. Control buttons 534 provide any number of “on” settings which control whether one or both vibrators are activated, as well as controlling the speed and/or intensity of the resultant vibration. In a preferred embodiment, the power supply and control means is further equipped with circuit board 538 which controls the functioning of control buttons 534 when controlling the speed, strength or rate of vibration. Arms 570, motor housing 560, and weight 564 are all contained within waterproof shell 580. The shell is further sealed to housing 530 to ensure a watertight seal between all electrical components and the external environment. In a preferred embodiment shell 580 is constructed of silicone, but any suitable material can be used such as rubber, vinyl, thermoplastic elastomer and the like. The shell is waterproof to prevent water or body fluids from contacting the internal portions of the device (as shown in FIG. 2). The shell is also durable so that it can withstand fairly vigorous use and subsequent cleanings. Shell 580 may further have shaped ends covering motor housing 560 and weight 564. In a preferred embodiment, sexual aid device 500 is constructed with rounded-over cylindrical ends similar to end 210 and end 220 as shown in FIG. 3. However, alternative shapes can be used such as knobbed or ribbed elements or shapes that resemble the head of a penis.

Although the invention has been described with reference to certain preferred embodiments, it will be appreciated by those skilled in the art that modifications and variations may be made without departing from the spirit and scope of the invention. It should be understood that applicant does not intend to be limited to the particular details described above and illustrated in the accompanying drawings.

1. A combination sexual aid and jewelry device comprising:
a housing for holding a power source connected to a first and a second flexible arm, where each of said first and second flexible arms has a distal end where at least one of said distal ends is equipped with an electro/mechanical means for causing a vibrating motion; and wherein said power source provides electrical power to said electro/mechanical means.

2. The device of claim 1 further including an outer, substantially continuous covering of an elastomeric material thereby creating a water-proof device.

3. The device of claim 2 wherein the elastomeric material comprises a pliable layer selected from the group consisting of silicone, rubber, vinyl and combinations thereof.

4. The device of claim 1 wherein said power source is a battery.

5. The device of claim 4 wherein said battery is a rechargeable battery.

6. The device of claim 5 further including a recharging outlet.

7. The device of claim 1 further including a switch connecting said power source to each of said electro/mechanical means.

8. The device of claim 7 wherein said switch includes multiple power settings for controlling said electro/mechanical means.

9. The device of claim 1 wherein said housing further holds a watch mechanism.

10. The device of claim 1 wherein each arm further includes a rigid yet flexible skeleton.

11. The device of claim 10 wherein said skeleton within each of said flexible arms is at least one coil spring.

12. The device of claim 10 wherein said skeleton within each of said flexible arms is two coil springs with said two coil springs joining at said electro/mechanical means.

13. The device of claim 1 wherein said flexible connecting arms are comprised of a plurality of ball-and-socket couplings.

14. The device of claim 1 wherein said electro/mechanical means for causing a vibrating motion is a vibrating motor.

15. The device of claim 14 further including an eccentric weight supported in a cantilever-fashion by a motor shaft on said vibrating motor.

16. The device of claim 1 wherein each of said flexible arms can bend freely so as to wrap around a user's wrist, ankle or neck.
